(19) United States
(12) Patent Application Publication
(10) Pub. No.: US 2003/0144892 A1
(43) Pub. Date: Jul. 31, 2003

(54) Method, system, and storage medium for providing knowledge management services

(75) Inventors: Charles R. Cowan, Poughkeepsie, NY (US); Kathryn Priest Reece, Marietta, GA (US)

Correspondence Address: Philmore H. Colburn, II, CANTOR COLBURN LLP, 55 Griffin Road South, Bloomfield, CT, 06002, US

(73) Assignee: International Business Machines Corporation, Armonk, NY

(21) Appl. No.: 10/058,351

(22) Filed: Jan. 29, 2002

(51) Int. Cl. G06F 17/60

(52) U.S. Cl. 705/8

(57) ABSTRACT

An exemplary embodiment of the invention relates to a method, system, and storage medium for providing knowledge management web services over a network. The system comprises at least one computer workstation coupled to a server via the network; one or more business applications executable via the server; a data storage device accessible to the server; and a knowledge management enabling tool executing on the server. The knowledge management enabling tool includes: a graphical user interface; at least one application programming interface; a solution environment; and a knowledge management enabling environment integrated with the business applications and the solution environment via the application programming interface. The knowledge management enabling tool facilitates receipt, classification, storage, and retrieval services relating to knowledge via the business applications. The knowledge management enabling environment includes a repository including a knowledge base which further comprises a metadata subcomponent configured to manage structured data, a binary large object subcomponent configured to manage unstructured data, a structuring component, a search component, and a collaboration component. Other embodiments of the invention include a method and storage medium for implementing knowledge management services.

### BACKGROUND

This invention relates generally to knowledge management systems, and more particularly, the present invention relates to a method, system, and storage medium for integrating knowledge management services with current or future computer applications in support of business processes.

Knowledge management has been defined as the ability to share and allow others to use the fundamental insights, understandings, and practical know-how that all individuals possess. It has also been defined as the ability to retain, analyze, manage, and maintain information, making it easily available to the right person, at the right time, anywhere in the world. In order to apply knowledge management today, knowledge workers use knowledge management (KM) applications to categorize, store, and manage knowledge artifacts and explicit knowledge. Knowledge artifacts refer to key pieces of information and documents that exist in a retrievable format for use by others. Explicit knowledge is experience (e.g., tacit knowledge that has been learned or acquired and that exists in the mind of a person) that has been codified and expressed in a retrievable form such as in documents, databases, etc. Knowledge workers use these KM applications and portals to search for and retrieve knowledge artifacts to be re-used or serve as examples or learning materials in performing their jobs. Various KM applications and portals have been developed by a number of software entities and are currently available in the market. The use of these tools requires knowledge workers to switch from the applications used to perform their jobs to the KM application and back again.

Many businesses today are turning their focus to knowledge enabling business processes using knowledge management tools. The concept of knowledge enabling business processes involves looking at current business processes and determining where knowledge could be re-used, where such knowledge may come from, and where it could be captured. Having found those touch points with the process, businesses would then look at the applications (existing or new) that support those processes in order to assess how the knowledge-enabling environment can be tapped so that knowledge can be delivered or captured within the applications. Applications such as project management, risk analysis, document creation and management, and software development tools are commonly used to support these everyday business processes. Existing knowledge management tools on the market today offer some assistance in managing information; however, they are inaccessible to the user during the execution of job-specific applications. Because they operate independently of the underlying business applications, they must be continuously accessed by virtue of switching back and forth between the knowledge application and the business applications. As such, they do not support a mechanism for allowing knowledge workers to extract knowledge artifacts from or submit knowledge artifacts into a knowledge base while retaining the context of the existing applications. Current knowledge management tools also do not support the ability to create one or more GUIs and/or portals/portlets that can be tailored to user or business needs, for example, to enable one or more content management capabilities for use as parts of the knowledge base.

What is needed is a more efficient way to access and utilize knowledge artifacts and information without having to transfer in and out of running applications.

### BRIEF SUMMARY

An exemplary embodiment of the invention relates to a method, system, and storage medium for providing knowledge management web services over a network. The system comprises at least one computer workstation coupled to a server via the network; one or more business applications executable via the server; a data storage device accessible to the server; and a knowledge management enabling tool executing on the server. The knowledge management enabling tool includes: a graphical user interface operable for implementing knowledge presentation and knowledge maintenance; at least one application programming interface; a solution environment; and a knowledge management enabling environment integrated with the business applications and the solution environment via the application programming interface. The knowledge management-enabling tool facilitates receipt, classification, storage, and retrieval services relating to knowledge via the business applications. The knowledge management enabling environment includes a repository including a knowledge base which further comprises a metadata subcomponent configured to manage structured data, a binary large object subcomponent configured to manage unstructured data, a structuring component, a search component, and a collaboration component. Other embodiments of the invention include a method and a storage medium for implementing knowledge management services.

### BRIEF DESCRIPTION OF THE DRAWINGS

Referring now to the drawings wherein like elements are numbered alike in the several FIGURES:

FIG. 1 is a portion of a network system upon which the knowledge management-enabling tool is implemented in an exemplary embodiment;

FIG. 2 is a block diagram illustrating the individual components of the knowledge management-enabling tool in an exemplary embodiment;

FIG. 3 is a sample GUI search screen presented by the knowledge management-enabling tool in an exemplary embodiment;

FIG. 4 is a sample GUI screen for examining a selected knowledge artifact in an exemplary embodiment; and

FIG. 5 is a flowchart describing an example of the process of implementing knowledge management services of the knowledge management-enabling tool in an exemplary embodiment.

### DETAILED DESCRIPTION OF THE PREFERRED EMBODIMENT

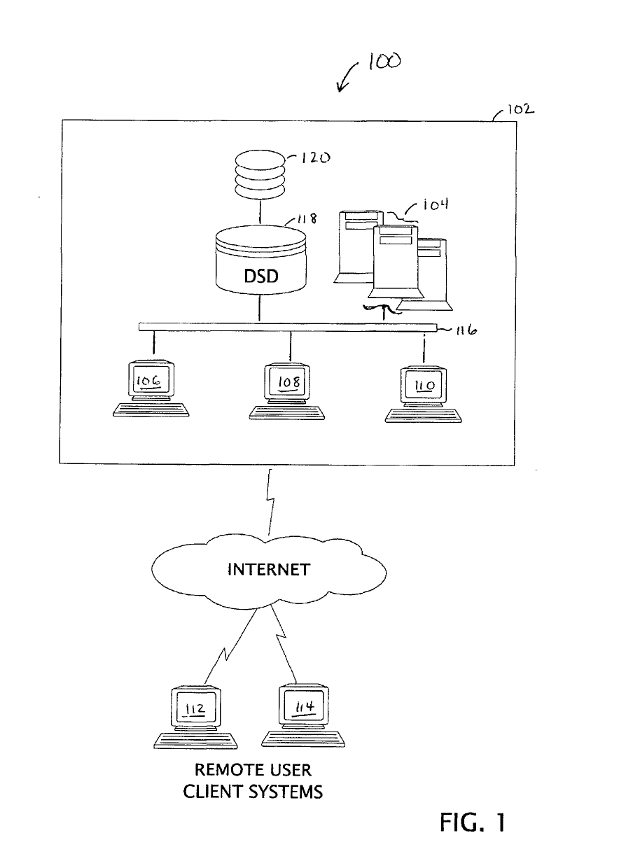

In an exemplary embodiment, the knowledge management-enabling tool is implemented via a network system such as that depicted in FIG. 1. System 100 may be part of a wide area network including multiple geographical locations that are interconnected by high-speed data lines or radio links. In the simplified diagram of FIG. 1, system 100 includes a business enterprise 102 operating in a client/server architecture mode and remote client systems 112 and 114 in communication with business enterprise 102 via the Internet. Business enterprise 102 comprises a server cluster 104 and data storage device 118 connected through a network 116 to client systems 106-110. Client systems 106-114 represent computer workstations operated by representatives of the business enterprise. These representatives may be low-level employees, business professionals, management, and system administrators. Client system 106 represents a workstation operated by a system administrator of enterprise 102. Client system 108 represents a workstation operated by a low-level or non-management employee of enterprise 102. Client system 110 represents a workstation operated by a manager of enterprise 102. Client systems 112 and 114 represent computer workstations operated by employees of a remote division of enterprise 102. It should be noted that any number of client systems may be utilized by business enterprise 102 and that each may have multiple peers, direct reports, and supervisors each of whom are operating a client system. For purposes of illustration, only five client systems 106-114 are shown. Each of client systems 106-114 may comprise a web-enabled personal computing device such as a desktop, laptop, or other similar apparatus known in the art. The term “business enterprise” refers to the organization implementing the knowledge management-enabling tool of the invention.

Network 116 may comprise a LAN, a WAN, or other network configuration known in the art. It will be understood that the knowledge-enabled business applications and the knowledge management enabling environment of the invention communicate through standard interfaces such as, but not limited to, hypertext transfer protocol (HTTP) and simple object access protocol (SOAP) and, thus, may be located anywhere and are capable of communicating across a LAN, WAN, Internet, etc. Further, the application programming interfaces (APIs) provided by the knowledge management enabling environment and used by the knowledge-enabled business applications utilize these types of web-enabled open standards protocols as well.

Network 116 may include wireless technology, radio-based communications, telephony-based communications, or a combination of the above. For purposes of illustration, however, network 116 is a LAN Intranet. Access is limited to internal devices and applications through a firewall or similar security system (not shown) which protects business enterprise 102 from unauthorized access and allows authorized remote client systems 112 and 114 to share and receive information from business enterprise 102. Business enterprise 102 is running suitable multi-platform supported server software for creating secure, interactive Internet, Intranet, and Extranet applications, and which allows information in data storage device 118 to be managed and presented to end users such as client systems 106-114 via business applications utilizing data management components (e.g., IBM's DB2™M) as well as presentation components (e.g., Lotus Domino™ and WebSphere™). Business enterprise 102 executes the knowledge management-enabling tool, among other applications via one or more servers of server cluster 104, client systems 106-114, or a combination of the above. Server cluster 104 allows business enterprise 102 to maintain up-to-date knowledge management materials and artifacts, general business data, and other information in a real-time environment through its replication features and web browsers. Servers in server cluster 104 share information with each other, as well as with client systems 106-114, storing the most current data for access by user systems.

Client systems 106-114 may access server cluster 104 via Lotus Notes™—compliant software located on client systems 106-114 or standard web browsers. Software may be Lotus Notes™ although it is not necessary in order to realize the advantages of the present invention.

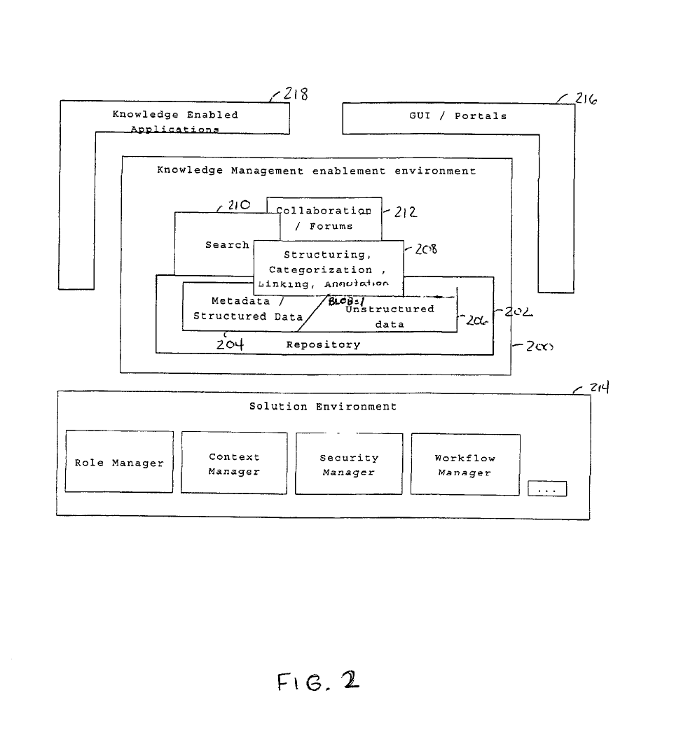

The knowledge management-enabling tool comprises various components including a knowledge management-enabling environment (200 of FIG. 2) that implements application programming interfaces (APIs) that are based on open standard web services such as, but not limited to, HTTP and SOAP. The APIs are utilized by business applications executed by business enterprise 102. Another component of the knowledge management-enabling tool is a solution environment (214 of FIG. 2). These and other components are discussed in further detail in FIG. 2. Business applications utilized by enterprise 102 may include project management, resource management, risk analysis, planning tools, industry specific applications, etc. Business enterprise 102 may also be running a groupware application such as Lotus Notes™ which allows client systems 106-114 to access information through its replication capabilities, provides e-mail services, and supports a secure intranet/extranet architecture. Enterprise 102 may also be running web-based business applications on one or more WebSphere™ servers of cluster 104, which support client systems 106-114 to access, update, and otherwise utilize information through standard web browsers such as Microsoft Internet Explorer™ or Netscape Navigator™.

Data storage device 118 resides within intranet 116 and may comprise any form of mass storage device configured to read and write database type data maintained in a file store (e.g., a magnetic disk data storage device). Data storage device 118 is logically addressable as a consolidated data source across a distributed environment such as network system 100. The implementation of local and wide-area database management systems to achieve the functionality of data storage device 118 will be readily understood by those skilled in the art. Information stored in data storage device 118 is retrieved and manipulated via one or more servers of server cluster 104.

A knowledge database 120 is associated with data storage device 118 and maybe accessed by the knowledge management-enabling tool in order to implement activities described herein. Knowledge database 120 stores information including artifacts, structured and unstructured data received from sources such as client systems 106-114. This and other information related to activities conducted via the knowledge management-enabling tool will be discussed further in FIGS. 2-5. Other information stored in data storage device 118 may include files, documents, spreadsheets, models, etc. resulting from business applications utilized in the daily operations of a business enterprise.

Data storage device 118 resides within enterprise's 102 intranet 116. Since it is within intranet 116, it may be made accessible to all of enterprise's 102 employees who have proper access permissions. That access may take place through business applications or through applications developed with specific graphical user interfaces (GUIs) specifically designed to manage knowledge artifacts. GUIs may be used for both knowledge presentation (e.g., a user is the executor of a process in the solution and/or knowledge enabling environment) and knowledge maintenance (e.g., a user is a trained knowledge worker with responsibility for the management and evolution of the knowledge content). Such applications and knowledge specific GUIs may be presented to the user through Lotus Notes™ clients, browsers, or other appropriate interfaces.

FIG. 2 illustrates the structural components of the knowledge management-enabling tool. Components include GUI/portals 216, knowledge-enabled business applications 218, a knowledge management-enabling environment 200, and a solution environment 214.

Knowledge management enabling environment 200 is integrated with knowledge-enabled business applications 218 and a solution environment 214 through the use of application programming interfaces (APIs) that allow the other components to request the services of knowledge management-enabling environment 200. The APIs are created utilizing open standards such as, but not limited to, web services, HTTP, SOAP, etc. Knowledge management enabling environment 200 includes a repository 202, a structuring component 208, a search component 210, and a collaboration component 212. Repository 202 contains the knowledge base 120 and resides in a central storage location such as data storage device 118. It comprises two parts: a metadata sub-component 204 and a BLOBs sub-component 206.

Metadata sub-component 204 manages structured (e.g., field) data, and is preferably implemented in a relational database. The metadata of a knowledge artifact refers to the information that places the knowledge contained in the artifact in context and allows users and applications to find the most appropriate artifact to meet their needs. Examples of metadata include the name of the person that created or codified the knowledge, the engagement or activity in which the artifact was created (e.g., a step in a process, work for a customer in a particular industry, a client name, pharmaceuticals being developed, etc.), the language in which the artifact was created, the country in which it was created, the technology or endeavor to which the artifact applies, etc.

The Binary Large OBject (BLOB) sub-component 206 manages unstructured data such as word processing, presentations, spreadsheet files, software programs, templates, etc. For example, a presentation made to a customer that resulted in a large sale, the spreadsheet used to prepare the price presented to the customer, and the meeting notes from the presentation are examples of BLOBs that would be stored in BLOB sub-component 206. BLOBs can also be industry specific, such as for example, process models, architectural diagrams, or structure models of pharmaceuticals being developed. The BLOBs of BLOB sub-component 206 are connected to the appropriate metadata of metadata sub-component 204. Therefore, the BLOBs referred to in the example above would be connected to the metadata providing the customer name, the date of the sales call, participants, the industry to which the customer belongs, the technologies and services sold to the customer, etc. Mechanisms readily understood by those skilled in the art can be used to extract text information from the BLOBs and to store the information as part of the metadata associated with the BLOBs in order to facilitate searches, categorization, indexing, and other activities relating to the content of the BLOBs.

Structuring component 208 allows knowledge artifacts received from client systems 106-114 to be categorized into one or more taxonomies. It also enables artifacts to be logically linked together so that these linked combinations can be retrieved as sets. This logical linking of artifacts allows a particular artifact to be utilized in the context of other, related artifacts. For example, an artifact exists that provides a written description of a work product. That work product description may be linked to other work products that were developed for different customer engagements. It may also be linked to technique papers that describe the steps in creating such a work product and to tools or templates that make it easier to create such a work product. A practitioner or knowledge worker obtaining this linked collection could use the metadata provided with these items to choose the one(s) that is/are most like the engagement he is working on. The API associated with knowledge enabling environment 200 may be used as a mechanism for specifying the criteria for which linked items are returned, thus saving the practitioner from searching through items that are not appropriate to the problem at hand.

Structuring component 208 also provides mapping capabilities from one taxonomy to another. People generally look for knowledge artifacts that they need in different ways depending on their individual needs and experiences. Thus, one taxonomy may not satisfy everyone. For example, to find an effective sales presentation, some may want to start by determining which industry the customer is in and what has worked well in that industry. Others may want to start by looking at the technology involved, or the specific business problem that the customer wants to solve. Therefore, structuring component 208 allows multiple taxonomies to be developed and the artifacts to be “mapped” or placed into the correct place with respect to each of the taxonomies. Mapping can be accomplished automatically using known technologies such as hard-coded rules, ‘similarity’ and ‘clustering’ algorithms, inference engines, etc. This allows a particular artifact to be found without regard to which taxonomy is most appropriate or “comfortable” for a particular user.

Structuring component 208 also allows artifacts to be annotated in order to provide additional information or indications of attributes such as quality or value. Employees responsible for the management of knowledge artifacts can benefit from having data concerning the effectiveness and timeliness of the artifacts that are available. The annotation function of structuring component 208 allows people who have found and utilized an artifact to communicate their judgment of the effectiveness of the artifact. Examples of items which would be part of an annotation would include a rating of the quality of the artifact, whether it is still current or perhaps out of date, the number of hours saved in reusing the artifact, the value or price placed on the artifact in a customer contract, etc. Search component 210 allows full text, graphic, and parametric (e.g., field level) searching of text in metadata or BLOBs. It uses structuring component 208 to enhance those searches using the taxonomies and logical links described above.

Collaboration component 212 adds collaboration functionality such as threaded discussions, forum management, shared calendars, document management, and bulletin boards to repository 202.

The knowledge management-enabling tool also comprises a solution environment 214 that includes components such as a role manager, context manager, process manager, security manager, workflow manager, etc. that can be used by the business applications and other components. These components of solution environment 214 generally represent the functionality that may be required for many business applications and thus should be provided in a common infrastructure rather than re-implemented in each application. Components of solution environment 214 may be proprietary in nature or may include commercially available products.

The role manager component of solution environment 214 may be used by a business application to obtain and manage information about the users of the application. In particular, the role manager can provide data such as the person's job code, their current assignment(s), the role or job that they are doing on a particular engagement, etc.

The context manager component of solution environment 214 maintains information relating to the business context in which a particular job is being done. For example, it can provide data such as the customer for which the work is being done, the stage of the project, the contract number, related projects, etc.

The security manager component of solution environment 214 utilizes business rules to verify and control the access that a particular user has to information and knowledge artifacts based on the context provided by the context manager above as well as the role that user has in the project.

The workflow manager component of solution environment 214 routes work or tasks to users identified as having particular roles. For example, if a user's role were to evaluate whether knowledge artifacts are of sufficient quality to be retained in repository 202, the workflow manager would recognize when a new artifact has been submitted to repository 202 and would route a work request to an assigned reviewer in order to make a determination of what should be done with the artifact. One option for the reviewer might be to indicate that the artifact needed to be improved in specific ways and the workflow manager would then send the artifact back to the originator with the reviewer's comments for further action.

Solution environment 214 includes the infrastructure necessary to support web services as described in FIG. 1. It will be understood that the composition of components of solution environment 214 may be modified to accommodate the needs of the business enterprise without departing from the spirit and scope of the invention.

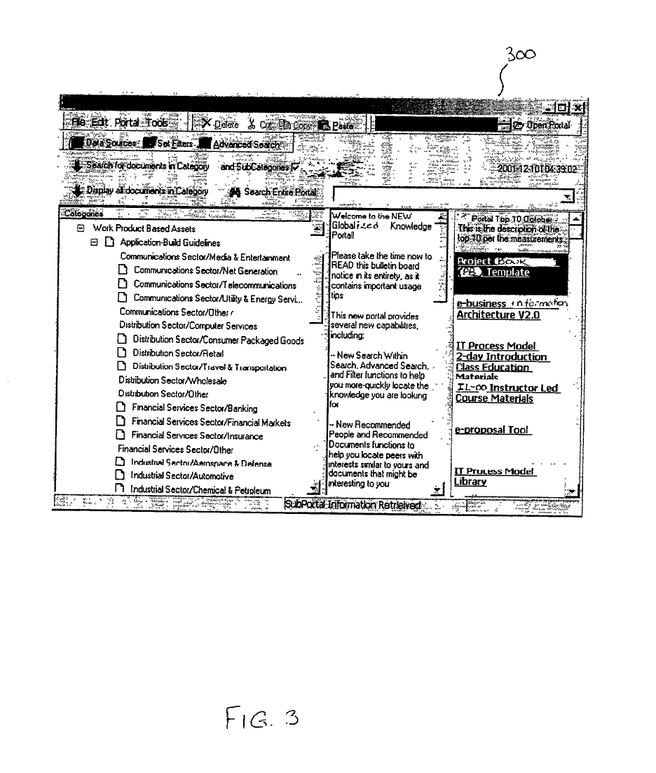

The knowledge management-enabling tool also comprises graphical user interface (GUI)/portals 216. GUI/portals 216 support content management in knowledge base 120 along with supporting workflow, and allow searching and direct access that can be accomplished using knowledge management enabling environment 200 APIs. GUIs 216 can be presented in the form of portlets within portals such as WebSphere™ portal server. GUI 216 is provided to allow those users that choose to, or need to because they are performing content management on the knowledge repository, work directly with the knowledge artifacts in knowledge repository 200. This might be someone who is looking for information that has not been delivered by a knowledge-enabled application, or wishes to have more specific control over a search. It may also be someone who is part of the team responsible for maintaining the content of repository 202 (e.g., to approve new content, to delete old content, or to modify the current content). A sample GUI search screen 300 is illustrated in FIG. 3. A knowledge worker at one of client systems 106-114 who would like to find a specific piece of information can initiate a search via search screen 300. A user can search by category, subcategories, key words, etc. as is shown generally in FIG. 3. Search screen 300 also provides important tips, notices, recommendations based on the user's interests, etc. Because the knowledge management-enabling environment 200 provides an API, more than one GUI could be created catering to the needs of specific user populations.

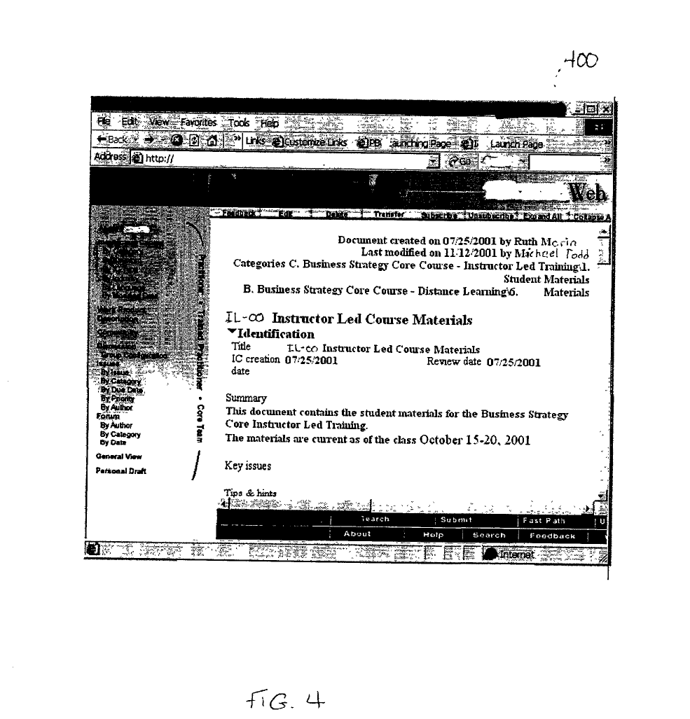

Once the user finds an item or artifact of interest, further details may be acquired by directly clicking on the item's link. Details of a sample artifact are shown in screen 400 of FIG. 4. The user can review details such as when the artifact was created, the date in which it was last modified, and other related information.

Finally, the knowledge management-enabling tool includes various knowledge-enabled applications 218 which comprise selected business applications that have been knowledge enabled by utilizing the KM enabling environment 200 APIs.

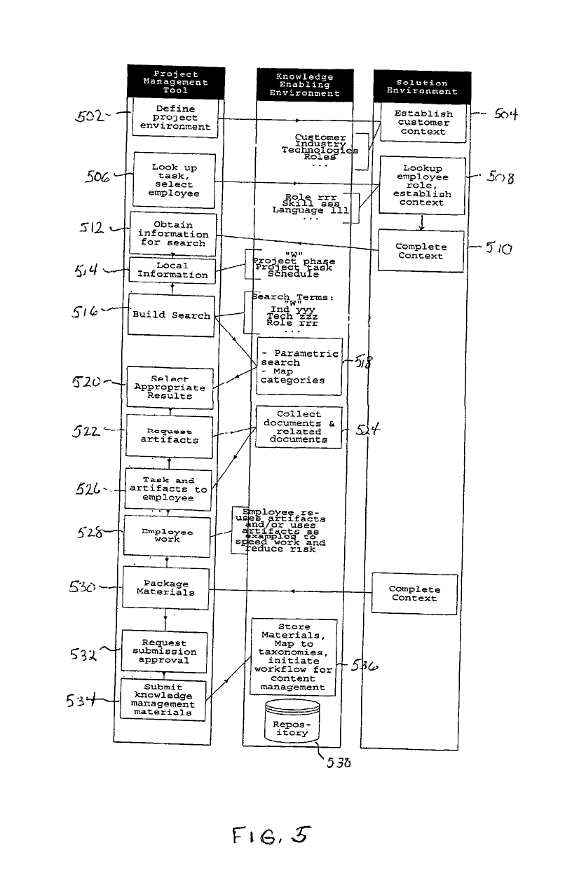

A framework for the flow of information associated with the implementation of the knowledge management-enabling tool is described in FIG. 5 with respect to the execution of a project management business application. It will be understood that other business applications such as risk analysis, supply chain management, materials and resource planning tools and industry specific applications are likely to be enhanced by the knowledge management enabling tool as well and that the project management tool has been selected for purposes of illustration only. For example, a risk management tool may request and deliver supporting examples and education materials from the knowledge management-enabling environment 200, based on context such as the industry, the size of the project, the technology involved in the project. A request may be sent to knowledge management enabling environment 200 whereby information such as sample risk mitigation documents or technique papers describing the steps to put into a project plan in order to manage risk are provided. Likewise, a supply chain tool may request supporting information from the knowledge management-enabling environment 200 when a user is experiencing difficulties in obtaining a particular type of part. The application could conduct a search via knowledge management-enabling environment 200, and retrieve documents describing past experiences with particular suppliers. Further, at the end of a particular supply cycle, the supply chain tool could query the users about their customer experiences and that “captured knowledge” could be submitted, in context, back into knowledge management enabling environment 200. For purposes of illustration, implementation of the knowledge management-enabling tool will be described with respect to a project management application.

A project management tool business application is initiated by a user. The user defines the project environment for a project that is being executed for a customer of business enterprise 102 in a particular industry involving a particular technology at step 502. This user may be a project manager at client system 110. A customer context is established via solution environment 214 at step 504. The customer context records information about the specific customer that the project is being done for. It includes the customer name, customer contacts (people), the industry, the contract information, products (technologies, services, etc.) sold as part of the engagement, the enterprise employees working with that customer, etc. This context is transferred to solution environment 214 whereby it is structured and stored for further access and sharing.

The project manager assigns a task to an employee, that task comprising the creation of a work product. The employee may be a user at one of client systems 108, 112, or 114. The project management tool looks up the task the employee is assigned at step 506. The employee's role is looked up via solution environment 214 at step 508 and a project and employee role context is established. The customer context, project context, and employee role context information is aggregated at step 510 and transferred to the project management tool at step 512 where search data is gathered. The search data may include the “role”, the “skills”, the “language”, the “industry”, the “technology”, etc., involved.

Local information such as specifics about the work product to be created and other constraints such as schedule deadlines are added to the search criteria at step 514. It includes data relating to the work product assigned, the project phase, task and schedule information. The project management tool builds a search request at step 516 using search terms acquired from step 510 and local information about the item being created and the context in which it is being created. The search may be built to utilize parametric criteria and/or categories that have been mapped for this type of context. The search is executed at step 518. Once the search has been completed, the project management tool selects the appropriate search results at step 520 and requests retrieval of selected artifacts at step 522. These are gathered at step 524 from documents stored in knowledge management enabling environment repository 202. In step 524, the knowledge management-enabling environment 200 can use the structuring information from structuring component 208 to collect and return related artifacts as well. The project management tool sends the assignment and materials to the employee at step 526. Sending this information can take many forms depending on the project management tool. For example, the assignment, including the description of the work product to be created, the examples and technique papers and the other materials retrieved from knowledge management-enabling environment 200 could be sent as an e-mail message to the employee directing completion of the assigned task. Another alternative is for the project management tool to populate a collaborative workplace used by the employee using the artifacts. It might then send an e-mail message with a link to the new materials in the workplace. The employee completes the assignment, creating the work product and other artifacts at step 528. These could be returned via e-mail or by indicating that the work product is complete in the collaborative space. In either case, the employee has worked in his normal process and application environment without having to switch to a “knowledge management” tool or environment while still having the advantage of the knowledge artifacts to speed and improve his work. The project management tool packages the work product with artifacts and context at step 530. The package materials comprise the work product, artifacts implemented by the employee as well as the completed context from solution environment 214. The project management tool displays the content of the package and asks the employee if the artifacts should be submitted at step 532. If the employee approves, the knowledge management materials are submitted to knowledge management-enabling environment 200 at step 534 where they are stored, mapped to taxonomies, and a workflow for content management is initiated at step 536. Results of project tasks are stored in repository 202 at step 538.

As can be seen, the knowledge management enabling tool allows knowledge workers to perform their jobs with knowledge management imbedded in the processes and job specific computer applications that they use. Knowledge is delivered within those job specific applications, anticipating the users needs and without their switching to a separate application to search for what they need. It also allows them to submit explicit knowledge back into the knowledge repository while retaining the “context”, (e.g., all of the additional information describing how and why the knowledge artifact was created, such as the person(s) involved, the project, the customer, the stage of the project, etc.) or whatever is necessary to facilitate retrieving the specific piece of knowledge when needed in the future.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A system for providing knowledge management services over a network, comprising:
at least one computer workstation;
a server operably coupled to said at least one computer workstation via said network;
a plurality of business applications executable via said server;
a data storage device storing information including files, documents, spreadsheets, models resulting from execution of said business applications, said data storage device accessible to said server;
a knowledge management enabling tool executing on said server, said tool including:
a graphical user interface operable for implementing knowledge presentation and knowledge maintenance;
at least one application programming interface;
a solution environment; and
a knowledge management enabling environment integrated with said plurality of business applications and said solution environment via said application programming interface;
wherein said knowledge management enabling tool facilitates receipt, classification, storage, and retrieval services relating to knowledge via said plurality of business applications.

2. The system of claim 1, wherein said knowledge management enabling environment includes:
a repository including a knowledge base, comprising:
a metadata subcomponent configured to manage structured data stored in said knowledge base;
a binary large object subcomponent configured to manage unstructured data stored in said knowledge base;
a structuring component;
a search component; and
a collaboration component.

3. The system of claim 2, wherein said structured data includes metadata relating to a knowledge artifact, said metadata placing it in a logical context.

4. The system of claim 2, wherein said unstructured data includes:
word processing files;
presentations;
spreadsheet files;
software programs;
templates; and
industry-specific information, including:
process models;
architectural diagrams; and
structure models of pharmaceuticals under development.

5. The system of claim 2, wherein said structuring component includes:
a means for categorizing knowledge artifacts into taxonomies;
a means for mapping said knowledge artifacts among related taxonomies;
a means for providing annotations to said knowledge artifacts; and
a means for logically linking together said knowledge artifacts.

6. The system of claim 5, wherein said knowledge artifacts are mapped into taxonomies via at least one of:
hard coded rules;
similarity algorithms;
clustering algorithms; and
inference engines.

7. The system of claim 2, wherein said search component facilitates full text, graphic, and parametric searching of said structured data and said unstructured data.

8. The system of claim 2, wherein said collaboration component includes a means for:
conducting threaded discussions;
implementing forum management;
providing shared calendars;
facilitating document management; and
providing electronic bulletin boards.

9. The system of claim 1, wherein said solution environment includes a web-enabled infrastructure of components, said components including at least one of:
a role manager;
a context manager;
a process manager;
a security manager; and
a workflow manager.

10. The system of claim 1, wherein said data storage device is accessible to said at least one computer workstation via an access control tool.

11. The system of claim 1, wherein said plurality of business applications include at least one of:
project management;
process management;
resource management;
risk analysis;
planning; and
industry-specific tools.

12. The system of claim 1, wherein said graphical user interface is presented to said at least one computer workstation in the form of a portlet within a portal.

13. The system of claim 1, wherein said graphical user interface is presented to said at least one computer workstation via a client technology including web browser technology.

14. The system of claim 2, wherein content management of said knowledge base is provided by said graphical user interface.

15. The system of claim 2, wherein said graphical user interface allows interaction with said knowledge base based on workflow provided by said solution environment.

16. The system of claim 2, wherein searching and access of said knowledge base is provided by said application programming interface and said graphical user interface.

17. The system of claim 1, wherein said application programming interface utilizes web-enabled open standards protocols.

18. The system of claim 1, wherein said network is an Internet network.

19. The system of claim 1, wherein said network is an Intranet network.

20. The system of claim 1, wherein said network is an Extranet network.

21. A method for providing knowledge management services relating to a project management business application executing on a server in conjunction with an applications programming interface and a knowledge management tool, comprising:
receiving data at a knowledge management enabling environment, said data relating to a project;
establishing a customer context relating to said project via a solution environment;
transferring said customer context to a solution environment;
structuring said customer context; and
storing said context in said solution environment.

22. The method of claim 21, further comprising:
retrieving data relating to a task, said task assigned to an individual via said project management tool; wherein said task comprises a directive to create a work product;
searching said solution environment for a role of said individual; and
establishing a project context and a role context.

23. The method of claim 22, further comprising:
aggregating said customer context, said project context, and said role context; and
transferring aggregated contexts to said project management tool.

24. The method of claim 23, further comprising:
gathering search data using terms found in said aggregated contexts and local information;
executing a search in a knowledge repository for knowledge artifacts relating to said project;
retrieving selected artifacts based upon search results; and
transferring said task and said selected artifacts to said individual.

25. The method of claim 24, further comprising:
upon completion of said task:
packaging said work product with said selected artifacts and said aggregated contexts resulting in a work package;
displaying content of said work package to said individual wherein:
said individual is requested to provide an approval status for submission of said selected artifacts to be included in said knowledge repository; and
upon approval of said selected artifacts, transferring said work package to said knowledge management enabling environment.

26. The method of claim 21, wherein said customer context includes information, including at least one of:
a customer name;
customer contact information;
customer industry;
contract information;
products involved; and
enterprise employees working with said customer.

27. The method of claim 24, wherein said search data includes at least one of:
a role;
skills;
language;
industry; and
technology.

28. The method of claim 24, wherein said local information includes work product information including at least one of:
schedule deadlines;
project phase data,
project task data; and
schedule information.

29. The method of claim 24, wherein said executing a search in a knowledge repository includes utilizing structuring information from a structuring component for collecting and returning said knowledge artifacts.

30. The method of claim 24, wherein said transferring said task and said selected artifacts to said individual includes providing at least one of:
a description of said task;
examples of similar work products; and
technique papers.

31. The method of claim 24, wherein said task and said selected artifacts are transferred via at least one of:
an email message to said individual; and
a collaborative workplace accessible to said individual via a link to said task and said selected artifacts in said workplace.

32. The method of claim 25, wherein said transferring said work package to said knowledge management enabling environment includes:
storing work package data;
mapping said work package data to associated taxonomies;
initiating a workflow operable for implementing content management of said work package data; and
storing results of said task in said knowledge repository.

33. A storage medium with machine-readable computer program code for providing knowledge management services relating to a project management business application executing on a server in conjunction with an applications programming interface and a knowledge management tool, the storage medium including instructions for causing said server to implement a method, comprising:
receiving data at a knowledge management enabling environment, said data relating to a project;
establishing a customer context relating to said project via a solution environment;
transferring said customer context to a solution environment;
structuring said customer context; and
storing said context in said solution environment.

34. The storage medium of claim 33, further comprising instructions for causing said server to implement:
retrieving data relating to a task, said task assigned to an individual via said project management tool; wherein said task comprises a directive to create a work product;
searching said solution environment for a role of said individual; and
establishing a project context and a role context.

35. The storage medium of claim 34, further comprising instructions for causing said server to implement:
aggregating said customer context, said project context, and said role context; and
transferring aggregated contexts to said project management tool.

36. The storage medium of claim 35, further comprising instructions for causing said server to implement:
gathering search data using terms found in said aggregated contexts and local information;
executing a search in a knowledge repository for knowledge artifacts relating to said project;
retrieving selected artifacts based upon search results; and
transferring said task and said selected artifacts to said individual.

37. The storage medium of claim 36, further comprising instructions for causing said server to implement:
upon completion of said task:
packaging said work product with said selected artifacts and said aggregated contexts resulting in a work package;
displaying content of said work package to said individual wherein:
said individual is requested to provide an approval status for submission of said selected artifacts to be included in said knowledge repository; and
upon approval of said selected artifacts, transferring said work package to said knowledge management enabling environment.

38. The storage medium of claim 33, wherein said customer context includes information, including at least one of:
a customer name;
customer contact information;
customer industry;
contract information;
products involved; and
enterprise employees working with said customer.

39. The storage medium of claim 36, wherein said search data includes at least one of:
a role;
skills;
language;
industry; and
technology.

40. The storage medium of claim 36, wherein said local information includes work product information including at least one of:
schedule deadlines;
project phase data,
project task data; and
schedule information.

41. The storage medium of claim 36, wherein said executing a search in a knowledge repository includes utilizing structuring information from a structuring component for collecting and returning said knowledge artifacts.

42. The storage medium of claim 36, wherein said transferring said task and said selected artifacts to said individual includes providing at least one of:
a description of said task;
examples of similar work products; and
technique papers.

43. The storage medium of claim 36, wherein said task and said selected artifacts are transferred via at least one of:
an email message to said individual; and
a collaborative workplace accessible to said individual via a link to said task and said selected artifacts in said workplace.

44. The storage medium of claim 37, wherein said transferring said work package to said knowledge management enabling environment includes:
storing work package data;
mapping said work package data to associated taxonomies;
initiating a workflow operable for implementing content management of said work package data; and
storing results of said task in said knowledge repository.
